(19) United States
(12) Patent Application Publication
(10) Pub. No.: US 2016/0338177 A1
(43) Pub. Date: Nov. 17, 2016

(54) LIGHTING CONTROL SYSTEM AND LIGHTING CONTROL METHOD

(71) Applicant: Azbil Corporation, Chiyoda-ku (JP)

(72) Inventor: Makoto KIKUCHI, Chiyoda-ku (JP)

(73) Assignee: Azbil Corporation, Chiyoda-ku (JP)

(21) Appl. No.: 15/152,821

(22) Filed: May 12, 2016

(30) Foreign Application Priority Data
May 15, 2015 (JP) 2015-099691

(51) Int. Cl. H05B 37/02; H04N 5/14; H04N 5/33

(52) U.S. Cl. CPC H05B 37/0227; H04N 5/33; H04N 5/147

(57) ABSTRACT

A lighting control system includes lighting equipment that illuminates an area; processing circuitry to sequentially obtain thermal images, each representing a spatial temperature distribution in the area at a corresponding time, determine whether a user is present in the area, based on one of the obtained thermal images, and determine whether the user is staying in the area, when it is determined that the user is present in the area, based on a change between the thermal images of the area sequentially obtained by the processing circuitry. The lighting control system further includes a control circuit to control the lighting equipment in accordance with whether the processing circuitry determines that the user is staying in the area.

### CROSS-REFERENCE TO RELATED APPLICATIONS

This application claims priority to Japanese Application No. 2015-099691, filed May 15, 2015, the entire contents of which are incorporated herein by reference.

### BACKGROUND

1. Field

The present disclosure relates to a lighting control system and a lighting control method, and more particularly to a lighting control system and a lighting control method for controlling the turning on and off of a plurality of pieces of lighting equipment located at a site.

2. Description of the Related Art

The related art, namely, Japanese Unexamined Patent Application Publication No. 2013-093103, discloses a lighting apparatus that detects the presence or absence of a person by using an infrared detecting device called a pyroelectric infrared sensor and that controls the turning on and off of lighting on the basis of the detection result.

The lighting apparatus disclosed by Japanese Unexamined Patent Application Publication No. 2013-093103 uses the characteristic that a change in illuminance and thermal movement simultaneously occur only when a person in an indoor space moves. The lighting apparatus includes an illuminance detector that outputs a high voltage when the environmental illuminance is higher than a reference illuminance and outputs a low voltage when the environmental illuminance is lower than the reference illuminance, and a pyroelectric infrared sensor serving as a human detector whose output value becomes H (high) when nobody is detected and becomes L (low) when a person is detected. The lighting apparatus performs AND processing of the outputs of the illuminance detector and the human detector, thereby reliably detecting the presence or absence of a person in an indoor space and controlling the turning on and off of lighting.

The lighting apparatus disclosed by Japanese Unexamined Patent Application Publication No. 2013-093103 detects a person on the basis of the detection results obtained by the illuminance detector and the human detector. When it is determined that the human detector has “detected a person” even though a person just passed by in front of the lighting apparatus, lighting equipment is turned on although that person is no longer in front of the lighting apparatus.

### SUMMARY

According to one embodiment, there is provided a lighting control system, comprising: (1) lighting equipment that illuminates an area; (2) processing circuitry configured to (a) sequentially obtain thermal images, each representing a spatial temperature distribution in the area at a corresponding time, (b) determine whether a user is present in the area, based on one of the obtained thermal images, and (c)determine whether the user is staying in the area, when it is determined that the user is present in the area, based on a change between the thermal images of the area sequentially obtained by the processing circuitry; and (3) a control circuit configured to control the lighting equipment in accordance with whether the processing circuitry determines that the user is staying in the area.

Further, in another embodiment, the control circuit is further configured to switch the lighting equipment from off to on when the processing circuitry determines that the user is staying in the area.

In another embodiment, the lighting control system according further includes second processing circuitry configured to (1) obtain an external thermal image including the user when the user is outside the area; (2) identify the user based on the external thermal image, when the processing circuitry determines the presence of the user in the area; and (3) determine whether the area determined by the processing circuitry to be an area where the user is staying is a predetermined home position of the user, wherein the control circuit is further configured to control the lighting equipment in accordance with whether the area is determined to be the predetermined home position of the user.

Further, in another embodiment, the control circuit is further configured to switch the lighting equipment from on to off when the processing circuitry determines that the user is no longer present in the area determined to be the predetermined home position of the user.

In another embodiment, there is provided a lighting control method, comprising (1) sequentially obtaining thermal images, each representing a spatial temperature distribution in an area at a corresponding time, the area being illuminated by lighting equipment; (2) determining, by processing circuitry, whether a user is present in the area, based on one of the obtained thermal images; (3) determining, by the processing circuitry, whether the user is staying in the area, when it is determined that the user is present in the area, based on a change between the thermal images of the area sequentially obtained; and (4) controlling, by a control circuit, the lighting equipment in the area when it is determined that the user is staying in the area.

### BRIEF DESCRIPTION OF THE DRAWINGS

FIG. 1 is a block diagram illustrating the overall configuration of a lighting control system according to a first embodiment of the present disclosure;

FIG. 2 is a diagram illustrating the state of arrangement of a thermopile and lighting equipment located in an internal space of a section;

FIG. 3 is a block diagram illustrating the configuration of a user area identifying apparatus according to the first embodiment;

FIG. 4 is a block diagram illustrating the configuration of a lighting controller;

FIG. 5 is a flowchart illustrating a process of turning on or off the lighting equipment according to the first embodiment;

FIG. 6 is a block diagram illustrating the overall configuration of a lighting control system according to a second embodiment of the present disclosure;

FIG. 7 is a diagram illustrating the state of arrangement of an entrance thermopile located outside the section, and indoor thermopiles and pieces of lighting equipment located inside the section;

FIG. 8 is a block diagram illustrating the configuration of a verification apparatus;

FIG. 9 is a block diagram illustrating the configuration of an entry/exit control apparatus;

FIG. 10 is a block diagram illustrating the configuration of the user area identifying apparatus;

FIG. 11 is a diagram illustrating a table registered in an equipment information database;

FIG. 12 is a flowchart for the description of a verification request process performed by the verification apparatus;

FIG. 13 is a flowchart for the description of an entry/exit control process performed by the entry/exit control apparatus; and

FIG. 14 is a flowchart illustrating a process of turning on or off the lighting equipment.

### DESCRIPTION OF THE PREFERRED EMBODIMENTS

Accordingly, it is an object of the present disclosure to provide a lighting control system and a lighting control method capable of controlling lighting equipment, located in a particular area, to be appropriately turned on and off only when a user is staying in that particular area.

In order to achieve the foregoing object, a lighting control system according to an aspect of the disclosure includes lighting equipment (LT4c), an obtaining unit (SP4c), a presence determining unit (52), a stay determining unit (53), and a controller (6). The lighting equipment (LT4c) illuminates a certain area (4c). The obtaining unit (SP4c) sequentially obtains a thermal image (H4c) representing a spatial temperature distribution in the area (4c) at a certain time interval. The presence determining unit (52) determines whether a user (UA) is present in the area (4c), on the basis of the thermal image (H4c) obtained by the obtaining unit (SP4c). The stay determining unit (53) determines whether the user (UA) is staying in the area (4c) determined by the presence determining unit (52) to be an area (4c) where the user (UA) is present, on the basis of a change between a plurality of thermal images (H4c, H4c′) sequentially obtained by the obtaining unit (SP4c) in the area (4c). The controller (6) controls the lighting equipment (LT4c) in accordance with a determination result obtained by the stay determining unit (53).

The controller (6) may switch the lighting equipment (LT4c) from off to on.

The lighting control system may further include: a second obtaining unit (SPE) that obtains a thermal image (H4c) including the user (UA) who is present outside the area (4c); a user identifying unit that identifies the user (UA) on the basis of the thermal image (H4c) including the user (UA) when the presence determining unit (52) determines a presence of the user (UA); and a fixed position determining unit (58) that determines whether the area (4c) determined by the stay determining unit (53) to be an area (4c) where the user (UA) is staying is a fixed position for the user (UA) to be naturally positioned. The controller (6) may control the lighting equipment (LT4c) in accordance with a determination result obtained by the fixed position determining unit (58).

The controller (6) may switch the lighting equipment (LT4c) from on to off when the presence determining unit (52) determines that the user (UA) is no longer present in the area (4c) determined by the fixed position determining unit (58) to be the fixed position.

A lighting control method according to another aspect of the disclosure includes: a first step of sequentially obtaining, with the use of an obtaining unit (SP4c), a thermal image (H4c) representing a spatial temperature distribution in a certain area (4c) at a certain time interval, the certain area (4c) being illuminated by lighting equipment (LT4c); a second step of determining, with the use of a presence determining unit (52), whether a user (UA) is present in the area (4c), on the basis of the thermal image (H4c) obtained in the first step; a third step of determining, with the use of a stay determining unit (53), whether the user (UA) is staying in the area (4c) determined in the second step to be an area (4c) where the user (UA) is present, on the basis of a change between a plurality of thermal images (H4c, H4c′) sequentially obtained in the first step in the area (4c); and a fourth step of controlling, with the use of a controller (6), the lighting equipment (LT4c) in the area (4c) when it is determined in the third step that the user (UA) is staying in the area (4c).

According to the aspects of the present disclosure, the lighting equipment (LT4c) can be appropriately controlled only when the user (UA) is staying in the area (4c) since the lighting equipment (LT4c) can be controlled only when it is determined that the user (UA) is staying in the area (4c).

A first embodiment and a second embodiment of the present disclosure will be described hereinafter with reference to the drawings.

### First Embodiment

A lighting control system according to the first embodiment is configured to control lighting equipment, located in a certain area of a room, which is an internal space, of a section located at a site, to turn on when a user enters that room and continuously stays in the area of that room, and not to turn on when the user simply passes by that area. The overall configuration of the lighting control system as mentioned here will be described below.

### Overall Configuration of Control System

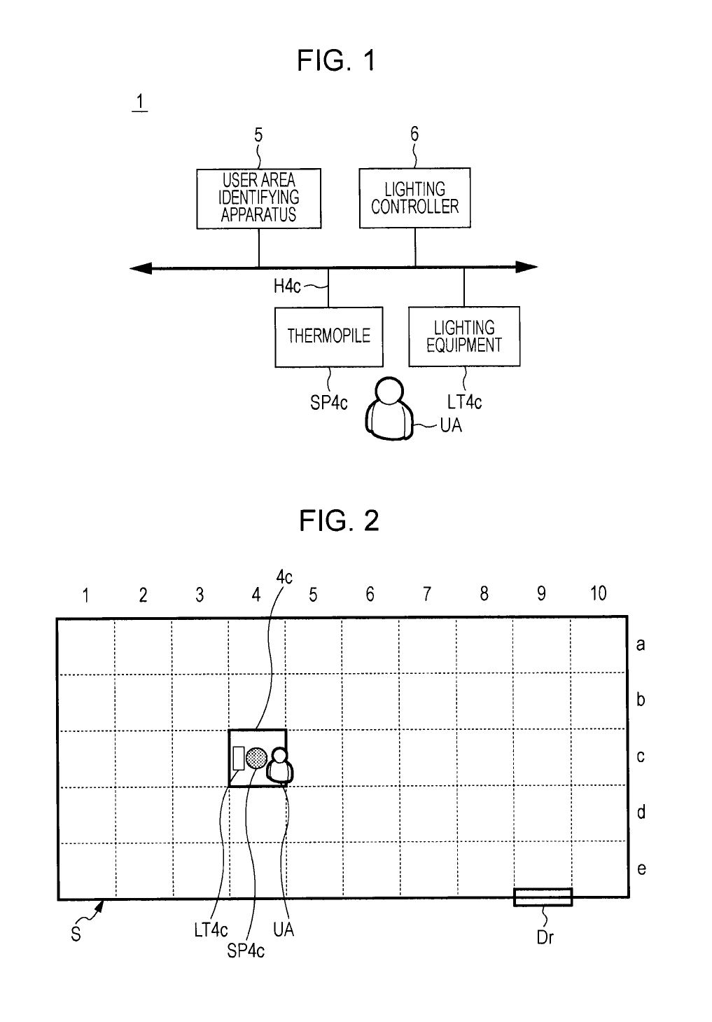

Referring to FIGS. 1 and 2, a lighting control system 1 includes a thermopile SP4c located in an area 4c of a room, which is an internal space, of a section S, lighting equipment LT4c located to be paired with the thermopile SP4c in the area 4c, a user area identifying apparatus 5 that identifies an area where a user UA is present, and a lighting controller 6 that controls the lighting equipment LT4c. The width of the area 4c is determined on the basis of a field of view unique to the thermopile SP4c.

### Thermopile

The thermopile SP4c is an infrared detection sensor array including a plurality of infrared detection sensors arranged two dimensionally. Each of the infrared detection sensors generates a thermoelectromotive force in accordance with the amount of incident energy of infrared rays radiated from an object.

The thermopile SP4c is located on the ceiling of, for example, the area 4c, which is one of a plurality of areas 1a to 10e obtained by virtually dividing the room, which is an internal space, of the section S at a site. With the use of the thermopile SP4c, a thermal image H4c corresponding to a space (area 4c) within a certain range can be obtained.

Alternatively, the thermopile SP4c may be located not only in the area 4c, but also in other necessary areas. Specifically, a thermopile is located in every area where lighting equipment is located.

### Lighting Equipment

The lighting equipment LT4c is lighting equipment including a fluorescent light or a light-emitting diode (LED), for example. The lighting equipment LT4c is located on the ceiling of the area 4c to be paired with the thermopile SP4c and illuminates that area 4c. The lighting controller 6 controls the lighting operation, such as turning on, turning off, and dimming, of the lighting equipment LT4c. The lighting equipment LT4c need not be located in the area 4c, and may be located outside the area 4c as long as the lighting equipment LT4c is able to illuminate the area 4c.

### User Area Identifying Apparatus

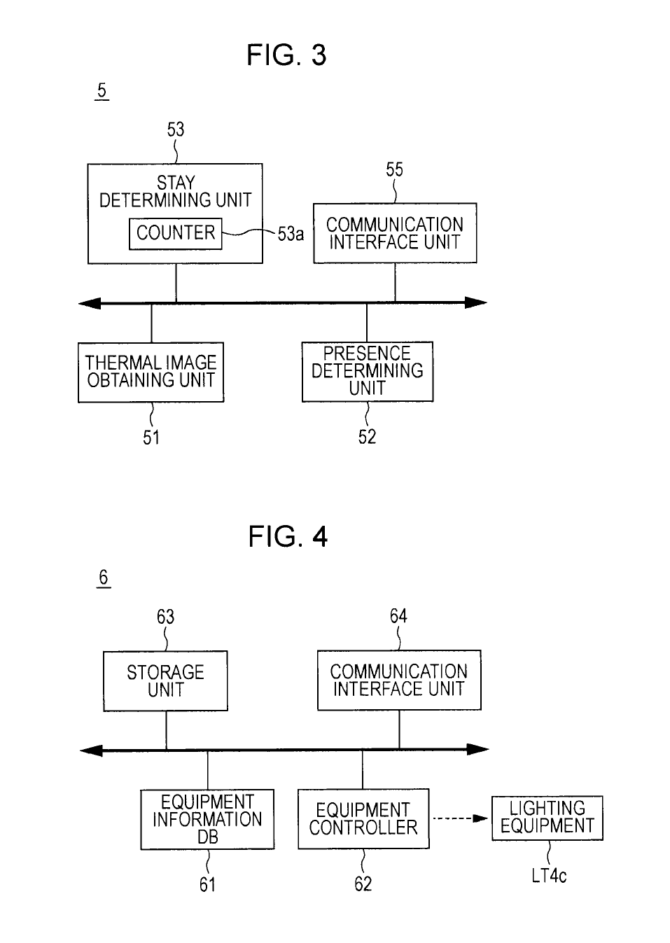

Referring to FIG. 3, the user area identifying apparatus 5 includes a thermal image obtaining unit 51, a presence determining unit 52, a stay determining unit 53, a communication interface unit 55, and so forth.

The thermal image obtaining unit 51 is a function unit that obtains the thermal image H4c of the area 4c from the thermopile SP4c via a network.

The presence determining unit 52 is a function unit that determines whether the user UA is present in the area 4c. The presence determining unit 52 includes an internal memory and an arithmetic operation unit.

The internal memory in the presence determining unit 52 stores a thermal image RE4c obtained by the thermopile SP4c in a state where there is no user UA in the area 4c, and a threshold th1 for determining the presence of the user UA. The thermal image RE4c is a reference image obtained in a state where there is no user UA, and is used as a reference for performing an arithmetic operation with the thermal image H4c obtained by the thermopile SP4c.

The arithmetic operation unit in the presence determining unit 52 performs an arithmetic operation on the basis of the thermal image H4c, obtained by the thermal image obtaining unit 51, and the reference thermal image RE4c, stored in the internal memory.

Specifically, the arithmetic operation unit in the presence determining unit 52 calculates the average value of pixel values greater than or equal to a certain luminance level (hereinafter referred to as a “first difference”) df1 in a differential image between the thermal image H4c, obtained by the thermal image obtaining unit 51 when the user UA enters the area 4c, and the reference thermal image RE4c, stored in advance in the internal memory. The arithmetic operation unit in the presence determining unit 52 determines that there is the user UA in the area 4c when the first difference df1 exceeds the first threshold th1

After determining that there is the user UA in the area 4c on the basis of the first threshold th1, the arithmetic operation unit in the presence determining unit 52 outputs information of an area number AR4c indicating the area 4c to the stay determining unit 53. After determining that there is no user UA in the area 4c on the basis of the first threshold th1, the arithmetic operation unit in the presence determining unit 52 outputs that determination result and information of the area number AR4c to the lighting controller 6.

The stay determining unit 53 is a function unit that determines, when the presence determining unit 52 determines that there is the user UA in the area 4c on the basis of the first threshold th1, whether the user UA is continuously staying in the area 4c for a certain time or longer. The stay determining unit 53 includes a counter 53a, an internal memory, and an arithmetic operation unit.

The counter 53a in the stay determining unit 53 counts a common clock signal used in the lighting control system 1. The internal memory in the stay determining unit 53 stores a second threshold th2 for determining whether the user UA is continuously staying in the area 4c for a certain time or longer on the basis of the number of pixels greater than or equal to a certain luminance level (hereinafter referred to as a “second difference”) df2 in the differential image between two thermal images H4c.

The internal memory in the stay determining unit 53 also stores a third threshold th3 (th2<th3) for determining whether a third person different from the user UA is merely passing the area 4c or is staying in the area 4c with the user UA.

The arithmetic operation unit in the stay determining unit 53 determines whether the user UA is staying in the area 4c by using the second threshold th2, and determines whether a third person different from the user UA is merely passing the area 4c or is staying in the area 4c with the user UA by using the third threshold th3. The arithmetic operation unit in the stay determining unit 53 transmits the determination result based on the second threshold th2 or the determination result based on the third threshold th3, and information of the area number AR4c indicating the area 4c to the lighting controller 6 through the communication interface unit 55.

The communication interface unit 55 is a function unit that transmits the determination result obtained by the presence determining unit 52 and information of the area number AR4c to the lighting controller 6, or transmits the determination result obtained by the stay determining unit 53 and information of the area number AR4c to the lighting controller 6.

The thermal image obtaining unit 51, the presence determining unit 52, and the stay determining unit 53 in the user area identifying apparatus 5 are each realized by a central processing unit (CPU) through reading and executing a program.

### Lighting Controller

Referring to FIG. 4, the lighting controller 6 includes an equipment information database 61, an equipment controller 62, a storage unit 63, a communication interface unit 64, and so forth.

The equipment information database 61 is a database that records equipment information regarding the lighting equipment LT4c located in the area 4c of the section S. Specifically, the equipment information recorded in the equipment information database 61 includes the area number (AR4c) identifying the area 4c, equipment ID (LTD4c) identifying the lighting equipment LT4c, and equipment name (LT4c) identifying the lighting equipment LT4c.

The equipment controller 62 is a function unit that outputs, on receipt of the determination result obtained by the presence determining unit 52 or the stay determining unit 53 and information of the area number AR4c from the user area identifying apparatus 5 via the communication interface unit 64, a control command for controlling the lighting equipment LT4c corresponding to the equipment ID (LTD4c) of the area number AR4c.

The storage unit 63 stores the operation log of the lighting equipment LT4c under control of the equipment controller 62, for example.

### Operation of Lighting Control System

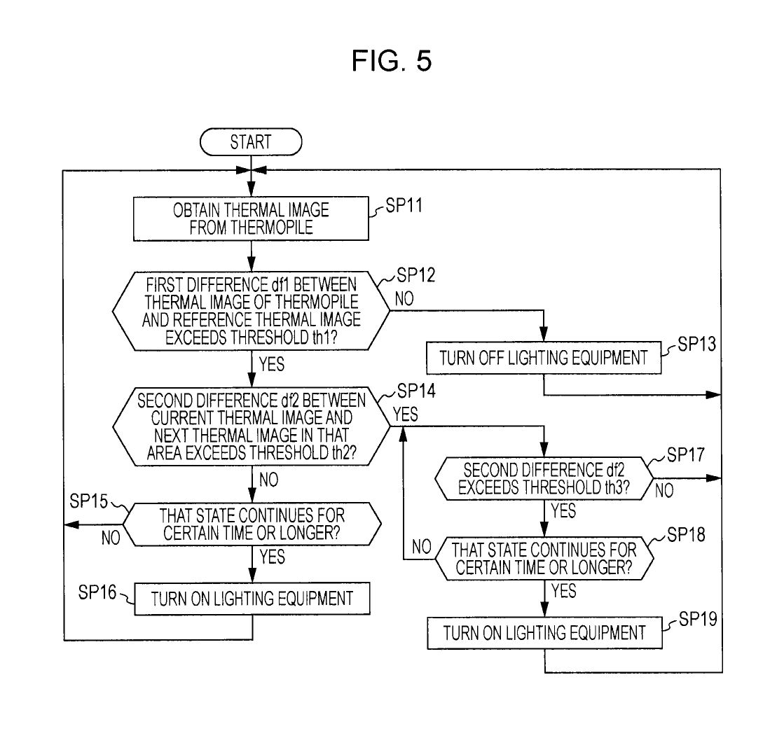

Referring next to the flowchart in FIG. 5, when the user UA enters a room, which is an internal space, of the section S in the lighting control system 1, a series of operations for determining, with the use of the user area identifying apparatus 5, whether the user UA is continuously staying in the area 4c, and controlling, with the use of the lighting controller 6, the lighting equipment LT4c located in the area 4c in accordance with the determination result will be described.

The user area identifying apparatus 5 in the lighting control system 1 obtains the thermal image H4c when the user UA, who has entered the room of the section S, is present in the area 4c, from the thermopile SP4c via the communication interface unit 55 (step SP11).

The presence determining unit 52 in the user area identifying apparatus 5 calculates the first difference df1 between the thermal image H4c including the user UA, obtained from the thermopile SP4c, and the reference thermal image RE4c stored in the internal memory, and determines whether the first difference df1 exceeds the first threshold th1 (step SP12).

When the presence determining unit 52 in the user area identifying apparatus 5 determines that the first difference df1 in the area 4c does not exceed the first threshold th1 (NO in step SP12), the presence determining unit 52 recognizes that there is no user UA in the area 4c, and outputs the determination result and information of the area number AR4c to the lighting controller 6. Therefore, the lighting controller 6 outputs a control signal for turning off the lighting equipment LT4c in the area 4c (step SP13), and returns to step SP11 again.

In contrast, when the presence determining unit 52 in the user area identifying apparatus 5 determines that, for example, the first difference df1 exceeds the first threshold th1 in the area 4c (YES in step SP12), the presence determining unit 52 determines that there is the user UA in the area 4c.

On receipt of the information of the area number AR4c from the presence determining unit 52, the stay determining unit 53 in the user area identifying apparatus 5 calculates the second difference df2 between the current thermal image H4c and a thermal image H4c′ obtained at the next time point in the area 4c with the area number AR4c, and determines whether the second difference df2 exceeds the second threshold th2 (step SP14). Since the thermopile SP4c obtains ten thermal images H4c per second, for example, the second difference df2 is calculated at intervals of 0.1 seconds.

When the stay determining unit 53 in the user area identifying apparatus 5 determines that the second difference df2 in the area 4c does not exceed the second threshold th2 (NO in step SP14), the stay determining unit 53 recognizes that the user UA, who may be moving very slightly, stays in the area 4c, and determines whether that state continues for a certain time (such as five seconds) or longer (step SP15).

When the stay determining unit 53 in the user area identifying apparatus 5 determines that the state in which the second difference df2 in the area 4c does not exceed the second threshold th2 does not continue for the certain time (such as five seconds) or longer by using the counter 53a (NO in step SP15), the stay determining unit 53 recognizes that the user UA has moved out of the area 4c, and returns to step SP11 again.

When the stay determining unit 53 in the user area identifying apparatus 5 determines that the state in which the second difference df2 in the area 4c does not exceed the second threshold th2 continues for the certain time (such as five seconds) or longer by using the counter 53a (YES in step SP15), the stay determining unit 53 recognizes that the user UA is continuously staying in the area 4c for the certain time or longer, and transmits the determination result and information of the area number AR4c to the lighting controller 6 via the communication interface unit 55.

On receipt of the determination result and the information of the area number AR4c from the user area identifying apparatus 5 via the communication interface unit 64, the lighting controller 6 outputs a control command for turning on the lighting equipment LT4c corresponding to the equipment ID (LTD4c) of the area number AR4c. In doing so, the lighting controller 6 turns the lighting equipment LT4c from off to on (step SP16), thereby illuminating the surroundings of the user UA staying in the area 4c, and returns to step SP11 again.

Thereafter, when the presence determining unit 52 in the user area identifying apparatus 5 determines that the first difference df1 between the thermal image H4c, obtained by the thermopile SP4c, and the reference thermal image RE4c does not exceed the first threshold th1 (NO in step SP12), the presence determining unit 52 recognizes that the user UA has moved out of the area 4c, and outputs the determination result and information of the area number AR4c to the lighting controller 6.

The lighting controller 6 outputs a control command for turning off the lighting equipment LT4c in the area 4c on the basis of the determination result and the information of the area number AR4c, switches the lighting equipment LT4c from on to off (step SP13), and returns to step SP11 again.

In contrast, when the stay determining unit 53 in the user area identifying apparatus 5 determines that the second difference df2 exceeds the second threshold th2 (YES in step SP14), the stay determining unit 53 determines whether the second difference df2 exceeds the third threshold th3 (step SP17).

When the stay determining unit 53 in the user area identifying apparatus 5 determines that the second difference df2 in the area 4c does not exceed the third threshold th3 (NO in step SP17), this means that a third person different from the user UA has not been detected in the area 4c, and only the user UA has already moved out of the area 4c. At this time, the stay determining unit 53 returns to step SP11 again.

In contrast, when the stay determining unit 53 in the user area identifying apparatus 5 determines that the second difference df2 in the area 4c exceeds the third threshold th3 (YES in step SP17), this means that a third person different from the user UA has been detected in the area 4c.

The stay determining unit 53 in the user area identifying apparatus 5 determines whether the state in which the second difference df2 in the area 4c exceeds the third threshold th3 continues for a certain time (such as five seconds) or longer (step SP18).

When the stay determining unit 53 in the user area identifying apparatus 5 determines that the state in which the second difference df2 in the area 4c exceeds the third threshold th3 does not continue for the certain time (such as five seconds) or longer by using the counter 53a (NO in step SP18), the stay determining unit 53 determines that a third person different from the user UA in the area 4c has passed the area 4c, or a third person together with the user UA has moved out of the area 4c. The stay determining unit 53 returns to step SP17 again without transmitting the determination result to the lighting controller 6.

When the stay determining unit 53 in the user area identifying apparatus 5 determines that the state in which the second difference df2 in the area 4c exceeds the third threshold th3 continues for the certain time (such as five seconds) or longer by using the counter 53a (YES in step SP18), the stay determining unit 53 determines that a third person together with the user UA is continuously staying in the area 4c for the certain time or longer, and transmits the determination result and information of the area number AR4c to the lighting controller 6 via the communication interface unit 55.

On receipt of the determination result and the information of the area number AR4c from the stay determining unit 53 in the user area identifying apparatus 5 via the communication interface unit 64, the lighting controller 6 outputs a control command for turning on the lighting equipment LT4c corresponding to the equipment ID (LTD4c) of the area number AR4c. In doing so, the lighting controller 6 switches the lighting equipment LT4c from off to on (step SP19), thereby illuminating the surroundings of the user UA and the third person staying in the area 4c, and returns to step SP11 again.

### Advantageous Effects

According to the lighting control system 1 described above, the lighting equipment LT4c located in the area 4c is simply kept at an off state when the user UA, who enters the room which is an internal space of the section S, merely passes the area 4c without staying in the area 4c. However, the lighting equipment LT4c in the area 4c can be switched from off to on when it is recognized that the user UA is continuously staying in the area 4c for a certain time or longer.

Thereafter, when the user UA, who has continuously stayed in the area 4c, moves out of and becomes away from the area 4c, the lighting control system 1 can immediately switch the lighting equipment LT4c from on to off.

In doing so, the lighting equipment LT4c can be turned on only during when the user UA is continuously staying in the area 4c and can be immediately turned off when the user UA moves out of the area 4c. Accordingly, the lighting control system 1 can appropriately control the turning on and off of the lighting equipment LT4c without losing comfort to the user UA who is staying in the area 4c.

Furthermore, when the user UA is continuously staying in the area 4c for the certain time or longer and the lighting equipment LT4c is turned on (steps SP11 to SP16), the lighting control system 1 is prevented from switching the lighting equipment LT4c from on to off when a third person merely passes the area 4c where the user UA is present (NO in steps SP14, SP17, and SP18).

When there is a third person in addition to the user UA in the area 4c and when both are continuously staying in the area 4c for the certain time or longer, the lighting control system 1 can switch the lighting equipment LT4c in the area 4c from off to on (steps SP11 to SP14, and SP17 to SP19).

When a pyroelectric infrared sensor that determines a change in temperature as detection of a person is used, the lighting equipment LT4c is turned on even when a person merely passes the area 4c, thereby uselessly consuming electric power.

However, the lighting control system 1 turns on the lighting equipment LT4c only when it is determined that the user UA is continuously staying in the area 4c by using the thermopile SP4c, which contactlessly and two-dimensionally detects the thermal image of the user UA. In doing so, the useless power consumption can be greatly reduced, compared with the case of using a pyroelectric infrared sensor.

### Second Embodiment

A lighting control system according to the second embodiment is configured to control lighting equipment, located in a certain area of a room, which is an internal space, of a section located at a site, to turn on when a user enters that room, moves within the room, and stays in the area of that room, and when it is determined that the area is a pre-registered fixed position (home position) for the user, and to turn off when it is determined that the area is not the fixed position. The overall configuration of the lighting control system as mentioned here will be described below.

### Overall Configuration of Control System

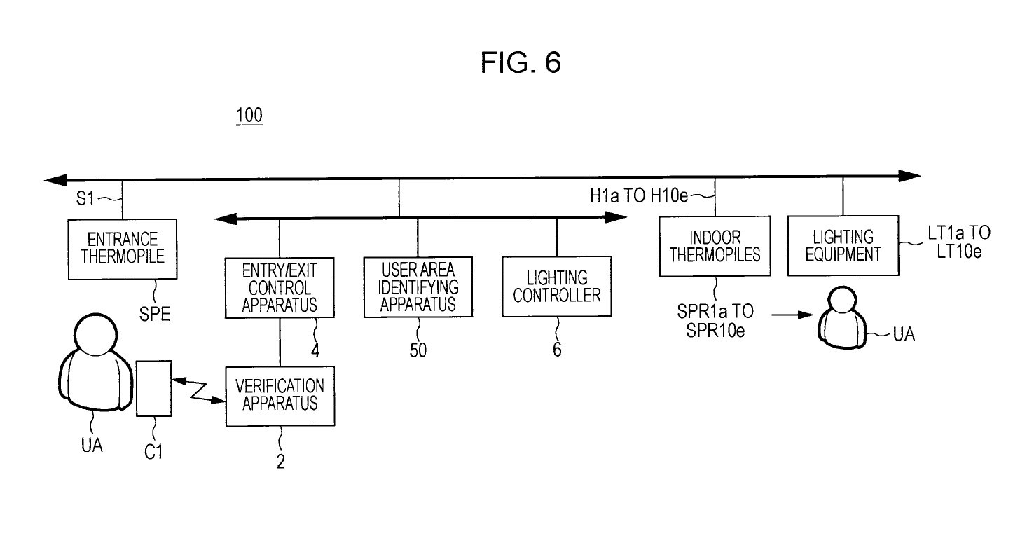

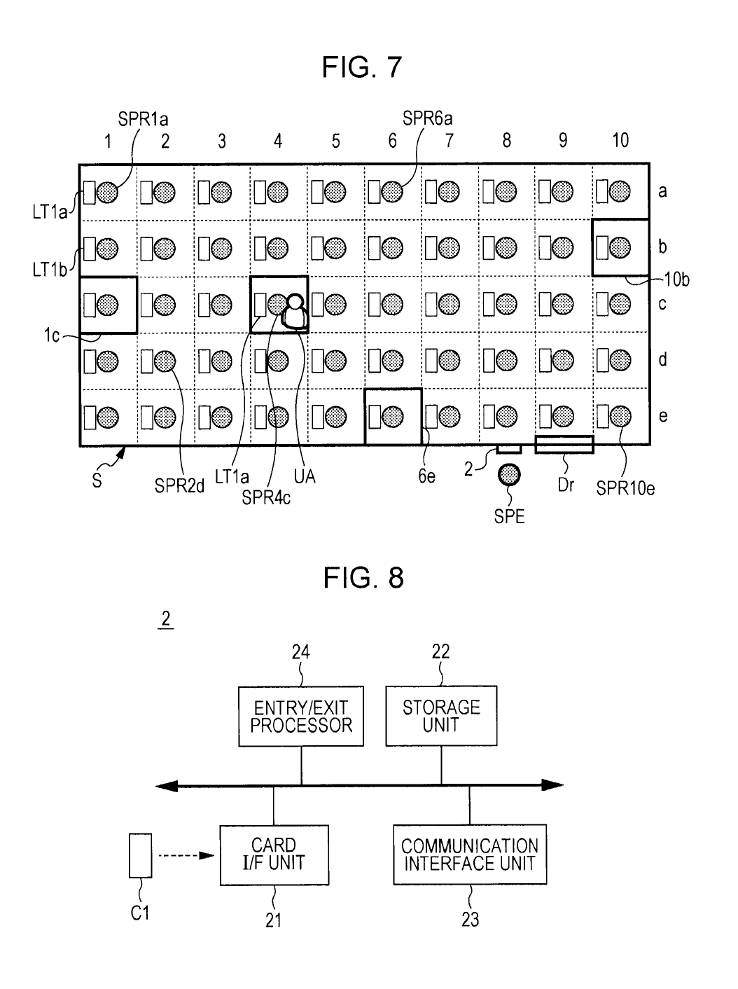

Referring to FIGS. 6 and 7, a lighting control system 100 includes a verification apparatus 2, an entrance thermopile SPE, an entry/exit control apparatus 4, indoor thermopiles SPR1a to SPR10e, pieces of lighting equipment LT1a to LT10e, a user area identifying apparatus 50, and the lighting controller 6. In the lighting control system 100 according to the second embodiment, the lighting controller 6 which is an element identical to that discussed in the lighting control system 1 according to the first embodiment is denoted by the same reference numeral, and a detailed description thereof is omitted.

### Entrance Thermopile

The entrance thermopile SPE is an infrared detection sensor array identical to the thermopile SP4c of the first embodiment.

The entrance thermopile SPE is located on the ceiling near the verification apparatus 2 located outside the section S, and is configured to obtain the thermal image of the user UA positioned in front of the verification apparatus 2. That is, the entrance thermopile SPE obtains a thermal image S1 of the user UA (hereinafter referred to as an “external thermal image S1”) while the user UA, positioned in front of the verification apparatus 2 near a door Dr, is giving a verification request using an ID card C1 on the verification apparatus 2.

### Indoor Thermopiles

The indoor thermopiles SPR1a to SPR10e are located at the ceiling of the room, which is an internal space, of the section S, at regular intervals, and are infrared detection sensor arrays that are identical to the thermopile SP4c of the first embodiment and to the entrance thermopile SPE.

The indoor thermopiles SPR1a to SPR10e are located on the ceiling of the plurality of areas 1a to 10e obtained by virtually and equally dividing the room, which is an internal space, of the section S. The width of each of the areas 1a to 10e is determined on the basis of a field of view unique to the indoor thermopile.

That is, the indoor thermopiles SPR1a to SPR10e cover all the areas 1a to 10e of the internal space of the section S. The indoor thermopiles SPR1a to SPR10e obtain thermal images (hereinafter referred to as “internal thermal images”) H1a to H10e, which are pieces of information on the spatial temperature distribution in the areas 1a to 10e.

Alternatively, the indoor thermopiles SPR1a to SPR10e may be located only in necessary areas, instead of being located in the individual areas 1a to 10e. Specifically, an indoor thermopile is located only in an area where lighting equipment is located, and an indoor thermopile need not be located in an area where no lighting equipment is located.

### Lighting Equipment

The pieces of lighting equipment LT1a to LT10e are lighting equipment including a fluorescent light or an LED, for example, like the lighting equipment LT4c of the first embodiment.

The pieces of lighting equipment LT1a to LT10e are located on the ceiling of the areas 1a to 10e to be paired with the indoor thermopiles SPR1a to SPR10e, respectively, and illuminate spaces in the areas 1a to 10e. The lighting controller 6 controls the lighting operation, such as turning on, turning off, and dimming, individually in the areas 1a to 10e. The pieces of lighting equipment LT1a to LT10e are not necessarily located in all the areas 1a to 10e, and may be located outside the areas 1a to 10e as long as the pieces of lighting equipment LT1a to LT10e are able to illuminate the areas 1a to 10e, respectively.

### Verification Apparatus

The verification apparatus 2 is a function unit that includes a card reader, for example, and that verifies the user UA who is trying to enter the room, which is an internal space, of the section S.

The verification apparatus 2 has the function of reading a user ID for identifying the user UA, who is entering/exiting the door Dr of the section S, from an identification (ID) card Cl that the user UA possesses, and notifies the entry/exit control apparatus 4 of the user ID when the user UA places the ID card C1 over a card antenna of the verification apparatus 2.

The verification apparatus 2 also has the function of notifying the entry/exit control apparatus 4 of unique apparatus identification information assigned to the verification apparatus 2, together with the user ID of the user UA.

Note that the verification apparatus 2 is not limited to a contactless card reader that contactlessly reads the user ID from the ID card C1, and may be a contact-type card reader that reads the user ID from the ID card C1 inserted into a card slot. Alternatively, a verification apparatus that uses biometric information such as the fingerprint, veins, and iris of the user UA may be used.

Referring to FIG. 8, the verification apparatus 2 includes a card interface unit 21, a storage unit 22, a communication interface unit 23, and an entry/exit processor 24 that manages the user UA's entering/exiting the section S.

The card interface unit 21 includes a dedicated interface circuit including a card antenna, and has the function of contactlessly reading, from the ID card C1, the user ID for identifying the user UA who enters/exits the section S in accordance with a card operation of the user UA using the ID card C1.

The storage unit 22 includes a storage device such as a semiconductor memory or a hard disk, and is configured to store the section ID of the section S where the verification apparatus 2 is located, the apparatus identification information unique to the verification apparatus 2, and the user ID read from the ID card C1 via the card interface unit 21.

The entry/exit processor 24 has the function of generating a verification request for determining whether to permit entry/exit, which includes the user ID read via the card interface unit 21, the section ID stored in the storage unit 22, and the apparatus identification information unique to the verification apparatus 2, and transmits the verification request to the entry/exit control apparatus 4 through the communication interface unit 23. Note that the entry/exit processor 24 is realized by a CPU through reading and executing a program.

The communication interface unit 23 is configured to exchange data between the verification apparatus 2 and the entry/exit control apparatus 4, which is higher in hierarchy than the verification apparatus 2. The communication interface unit 23 transmits to the entry/exit control apparatus 4 the above-mentioned verification request for determining whether to permit entry/exit, or receives from the entry/exit control apparatus 4 the result of determination of whether entry/exit is permitted. The result of determination of whether entry/exit is permitted is displayed on a display unit (not illustrated).

The ID card C1 includes a card-shaped portable storage medium for information processing, such as a memory card or an integrated circuit (IC) card. The ID card C1 stores a user ID unique to the user UA who possesses the ID card C1, which serves as information necessary for determining whether entry/exit is permitted to the user UA.

### Entry/Exit Control Apparatus

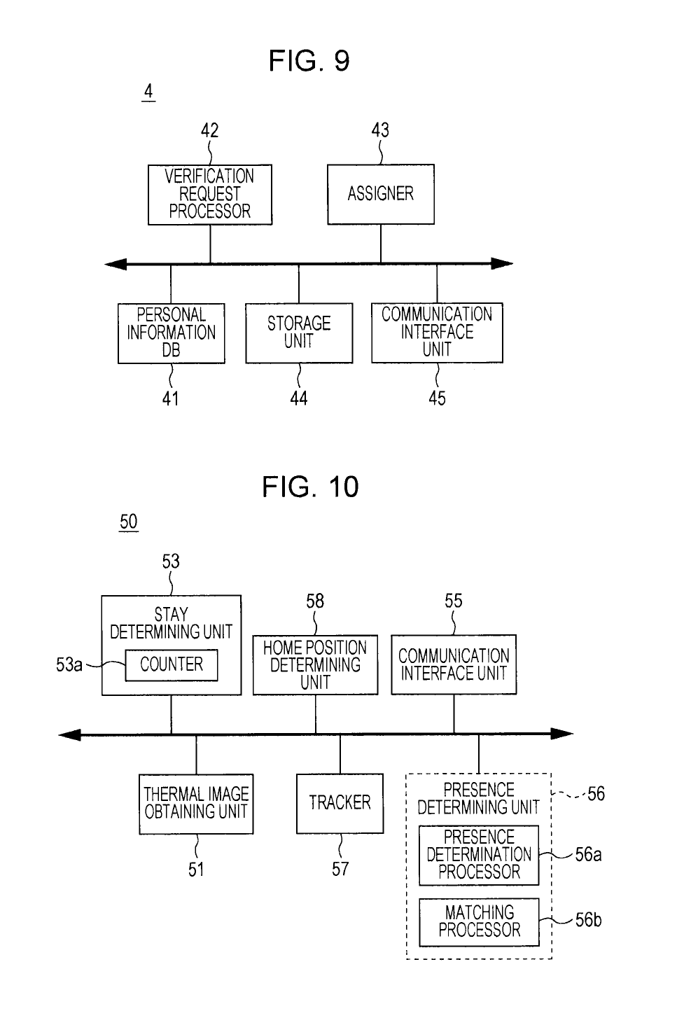

Referring to FIG. 9, the entry/exit control apparatus 4 includes a personal information database 41, a verification request processor 42, an assigner 43, a storage unit 44, and a communication interface unit 45.

The personal information database 41 is a database that stores personal information regarding the user UA who uses the section S. Specifically, the user ID and permitted section ID of the user UA are registered in the personal information database 41. The permitted section ID is an ID that indicates the section S that the user UA is permitted to enter/exit.

The verification request processor 42 has the function of obtaining the permitted section ID of the user UA, which is part of the personal information registered in the personal information database 41, in response to a verification request from the user UA, received from the verification apparatus 2 via the communication interface unit 45. The verification request processor 42 also has the function of verifying the permitted section ID against the section ID included in the verification request information from the verification apparatus 2, and determining whether to permit the user UA to enter/exit the section S. The verification request processor 42 also has the function of opening an electric lock of the door Dr of the section S in response to the result of determination of whether entry/exit is permitted.

The assigner 43 has the function of identifying in which section S the entrance thermopile SPE which has obtained the external thermal image S1 is located, on the basis of the apparatus identification information of the verification apparatus 2, included in the verification request from the verification apparatus 2, and assigns the user ID of the user UA, included in the verification request from the verification apparatus 2, to the external thermal image S1. In doing so, the entry/exit control apparatus 4 becomes able to associate the user ID of the user UA with the external thermal image S1 of the section S.

The storage unit 44 stores information such as the result of determination of whether entry/exit is permitted to the user UA, and the lock opening log.

The communication interface unit 45 has the function of receiving a verification request from the communication interface unit 23 in the verification apparatus 2, and transmitting the result of determination of whether entry/exit is permitted, which is obtained by the verification request processor 42, to the verification apparatus 2. The communication interface unit 45 also has the function of transmitting the external thermal image S1 of the user UA, to which the user ID is assigned by the assigner 43, to the user area identifying apparatus 50.

Note that the personal information database 41 and the storage unit 44 include storage devices such as semiconductor memories or hard disks, and the verification request processor 42 and the assigner 43 are each realized by a CPU through reading and executing a program.

### User Area Identifying Apparatus

Referring to FIG. 10, the user area identifying apparatus 50 includes the thermal image obtaining unit 51, a presence determining unit 56, a tracker 57, the stay determining unit 53, a home position determining unit 58, and the communication interface unit 55. In the user area identifying apparatus 50, the thermal image obtaining unit 51, stay determining unit 53, and communication interface unit 55 which are elements identical to those illustrated in the user area identifying apparatus 5 of the first embodiment are denoted by the same reference numerals, and overlapping descriptions thereof are omitted.

The thermal image obtaining unit 51 has the function of obtaining the external thermal image S1 of the user UA, transmitted from the entry/exit control apparatus 4 via a network. The thermal image obtaining unit 51 also has the function of obtaining the internal thermal images Hla to H10e of the areas 1a to 10e, transmitted respectively from the indoor thermopiles SPR1a to SPR10e via a network.

The presence determining unit 56 is a function unit that determines the area where the user UA is present, and includes a presence determination processor 56a and a matching processor 56b. The presence determination processor 56a has the function of determining in which of the areas 1a to 10e the user UA is present, and includes an internal memory and an arithmetic operation unit.

The internal memory in the presence determination processor 56a stores thermal images RE1a to RE10e obtained by the indoor thermopiles SPR1a to SPR10e in a state where there is no user UA, and the threshold th1 for determining the presence of the user UA.

The thermal images RE1a to RE10e are reference images that serve as reference, obtained by the indoor thermopiles SPR1a to SPR10e in a state where there is no user UA. The thermal images RE1a to RE10e are used for performing arithmetic operations with the internal thermal images H1a to H10e, obtained by the indoor thermopiles SPR1a to SPR10e in a state where the user UA is present.

The arithmetic operation unit in the presence determination processor 56a performs arithmetic operations on the internal thermal images H1a to H10e obtained by the indoor thermopiles SPR1a to SPR10e, obtained by the thermal image obtaining unit 51, and the reference thermal images RE1a to RE10e stored in the internal memory.

The matching processor 56b in the presence determining unit 56 has the matching function of determining whether the internal thermal image H4c of the area 4c where the presence of the user UA is determined by the presence determination processor 56a matches the external thermal image S1 in a state where the user UA is present, obtained from the entrance thermopile SPE via the thermal image obtaining unit 51, on the basis of the luminance level in units of pixels. Matching between the external thermal image S1 and the internal thermal image H4c is performed using a pattern matching technique of the related art.

Therefore, the matching processor 56b in the presence determining unit 56 determines that a person present in the area 4c is the user UA when the external thermal image S1 in a state where the user UA is present matches the internal thermal image H4c of the area 4c, and recognizes the area number AR4c of the area 4c corresponding to the number of the indoor thermopile SPR4c (hereinafter referred to as the “indoor thermopile number”) which has obtained the internal thermal image H4c that matches the external thermal image S1. In doing so, the matching processor 56b is able to identify that a person currently present in the area 4c with the area number AR4c, which is the recognition result, is the user UA.

The tracker 57 is a function unit that tracks chronological changes in the area (hereinafter referred to as the “matching area”) indicating the current position of the user UA, identified by the matching processor 52b in the presence determining unit 56. That is, the tracker 57 recognizes the area of the current position of the user UA in the internal space of the section S all the time by tracking the matching area, and outputs information of the area number AR indicating the current position (area) of the user UA to the stay determining unit 53.

The stay determining unit 53 is a function unit that determines whether the user UA is continuously staying in any of the areas 1a to 10e, and is configured like the first embodiment.

The home position determining unit 58 is a function unit that determines whether the area 4c, determined by the stay determining unit 53 as an area where the user UA is continuously staying, is a predetermined home position for the user UA to be naturally positioned, and includes an internal memory and an arithmetic operation unit.

The home position is a fixed position determined in advance for the user UA. When a desk of the user UA is located in the area 4c, for example, that area 4c is registered as the home position for the user UA.

The internal memory in the home position determining unit 58 associatively stores the user ID of the user UA and one of the area numbers AR1a to AR10e registered as the home position for the user UA. The arithmetic operation unit in the home position determining unit 58 has the function of determining whether the area 4c with the area number AR4c determined via the stay determining unit 53 is registered as a fixed position (home position) for the user UA, on the basis of the user ID.

The communication interface unit 55 is a function unit that, when the home position determining unit 58 determines that the area 4c is a fixed position (home position) for the user UA, transmits the determination result and information of the area number AR4c of the area 4c to the lighting controller 6 via a network.

The thermal image obtaining unit 51, presence determining unit 52, tracker 57, stay determining unit 53, and home position determining unit 58 are each realized by a CPU through reading and executing a program.

### Lighting Controller

The lighting controller 6 (see FIG. 4) has a configuration like the first embodiment, and includes the equipment information database 61, equipment controller 62, storage unit 63, communication interface unit 64, and so forth.

The equipment information database 61 is a database that stores equipment information regarding the pieces of lighting equipment LT1a to LT10e located respectively in the areas 1a to 10e, which are obtained by virtually dividing the room, which is an internal space, of the section S.

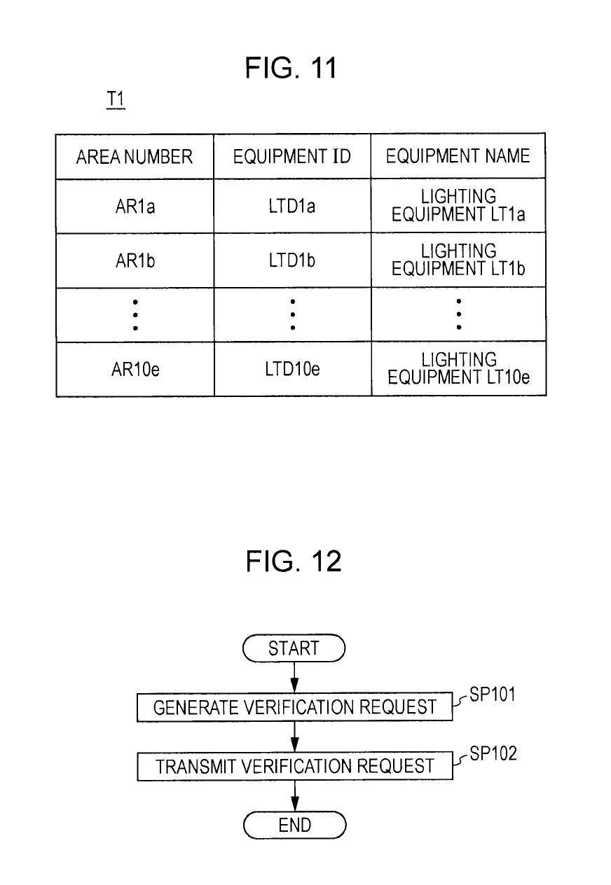

Specifically, the equipment information database 61 includes a table T1 where the area numbers (AR1a to AR10e) for identifying the areas 1a to 10e, equipment IDs (LTD1a to LTD10e), and equipment names (pieces of lighting equipment LT1a to LT10e) are associated with one another, as illustrated in FIG. 11.

The equipment controller 62 is a function unit that outputs, on receipt of the determination result and information of the area number from the presence determining unit 56 or the home position determining unit 58 in the user area identifying apparatus 50, a control command for controlling the lighting equipment corresponding to the equipment ID of the area number. The storage unit 63 stores the operation log of the lighting equipment controlled by the equipment controller 62, for example.

### Operation of Lighting Control System

Referring next to the flowcharts in FIGS. 12 to 14, when the verification apparatus 2 and the entry/exit control apparatus 4 in the lighting control system 100 identify the user UA and when the user UA enters a room, which is an internal space, of the section S, if in which area of the room of the section S the user UA is continuously staying is determined, an operation for controlling the lighting equipment LT located in that area in response to the result of determination of whether that area is a home position for the user UA will be described.

Referring to FIG. 12, the verification apparatus 2 in the lighting control system 100 generates a verification request on the basis of the user ID read from the ID card C1 of the user UA (step SP101), transmits the verification request to the entry/exit control apparatus 4 through the communication interface unit 23 (step SP102), and ends the verification request process.

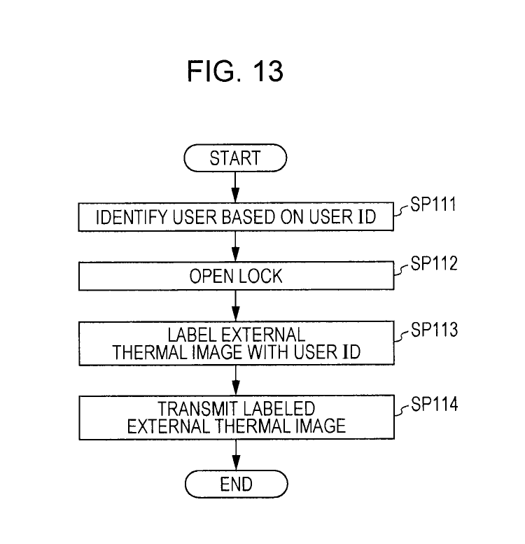

Referring to FIG. 13, the entry/exit control apparatus 4 in the lighting control system 100 identifies the user UA on the basis of the user ID included in the verification request received from the verification apparatus 2 (step SP111). At the same time, the entry/exit control apparatus 4 identifies that the verification apparatus 2 is located in the section S, on the basis of the apparatus identification information unique to the verification apparatus 2, which is included in the verification request.

Since the entry/exit control apparatus 4 has been able to identify the user UA and the section S, the entry/exit control apparatus 4 opens the electric lock of the door Dr of the section S (step SP112), assigns and attaches the label of the user ID of the user UA to the external thermal image S1 obtained by the entrance thermopile SPE of the section S (step SP113), transmits the external thermal image S1 of the user UA, to which the user ID is assigned, to the user area identifying apparatus 50 (step SP114), and ends the entry/exit control process.

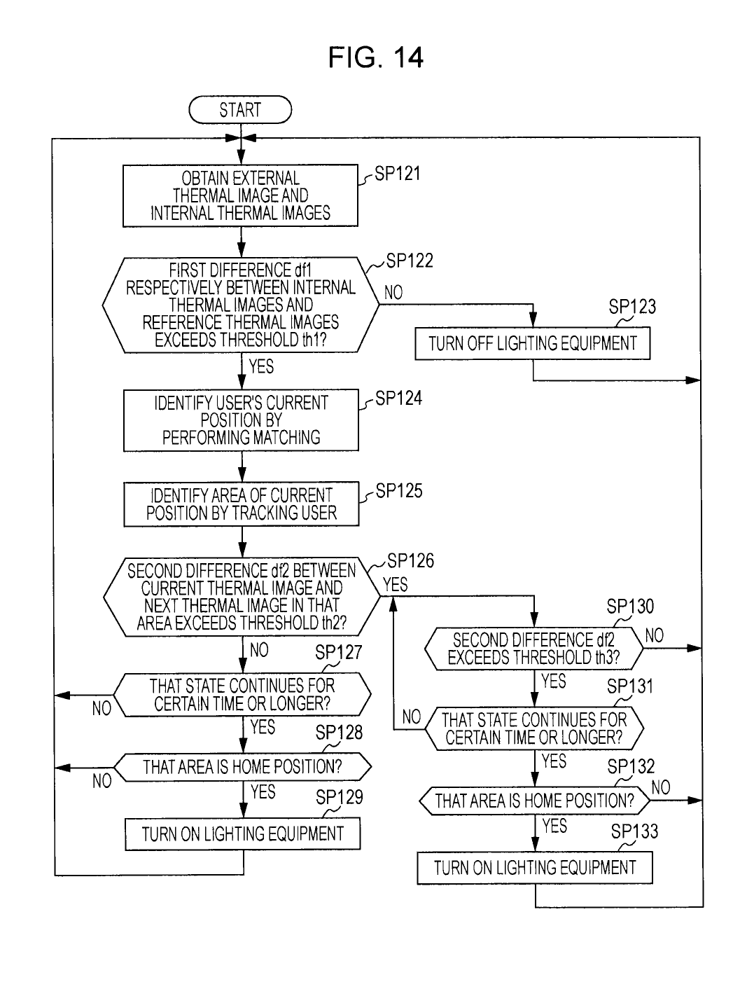

Referring to FIG. 14, the user area identifying apparatus 50 in the lighting control system 100 receives the external thermal image S1 obtained via the entrance thermopile SPE, and the internal thermal images H1a to H10e obtained via the indoor thermopiles SPR1a to SPR10e, through the communication interface unit 55 (step SP121).

The presence determining unit 56 in the user area identifying apparatus 50 calculates the first difference df1 respectively between the internal thermal images H1a to H10e, obtained by the indoor thermopiles SPR1a to SPR10e, and the reference thermal image RE1a to RE10e, and determines whether the first difference df1 exceeds the first threshold th1 (step SP122).

When the presence determining unit 56 in the user area identifying apparatus 50 determines that the first difference df1 does not exceed the first threshold th1 (NO in step SP122), the presence determining unit 56 recognizes that there is no user UA in the areas 1a to 10e, that is, the user UA has not entered the room, which is an internal space, of the section S, and outputs the determination result to the lighting controller 6. Therefore, the lighting controller 6 outputs a control signal for turning off the lighting equipment LT in every area on the basis of the determination result (step SP123), and returns to step SP121 again.

In contrast, when the presence determining unit 56 in the user area identifying apparatus 50 determines that the first difference dfl exceeds the first threshold th1 (YES in step SP122), the matching processor 56b determines that the internal thermal image H4c of the area 4c, for example, where the presence of the user UA is determined by the presence determination processor 56a, and the external thermal image S1 including the user UA match each other, identifies that a person currently positioned in the area 4c is the user UA, and then outputs information of the area number AR4c to the tracker 57 (step SP124).

Thereafter, the tracker 57 in the user area identifying apparatus 50 monitors chronological changes in the matching area, thereby tracking and identifying the area where the user UA is currently positioned (step SP125).

The stay determining unit 53 in the user area identifying apparatus 50 calculates the second difference df2, which is a change between the thermal image H4c obtained by the indoor thermopile SPR4c in the area 4c with the area number AR4c where the user UA is currently positioned and a thermal image H4c′ obtained at the next time point, and determines whether the second difference df2 exceeds the second threshold th2 (step SP126).

When the stay determining unit 53 in the user area identifying apparatus 50 determines that the second difference df2 does not exceed the second threshold th2 (NO in step SP126), the stay determining unit 53 recognizes that the user UA is staying in the area 4c, and determines whether that state continues for a certain time (such as five seconds) or longer (step SP127).

When the stay determining unit 53 in the user area identifying apparatus 50 determines that the state in which the second difference df2 does not exceed the second threshold th2 does not continue for the certain time (such as five seconds) or longer by using the counter 53a (NO in step SP127), the stay determining unit 53 determines that the user UA is not continuously staying in the area 4c for the certain time or longer, and returns to step SP121 again.

When the stay determining unit 53 in the user area identifying apparatus 50 determines that the state in which the second difference df2 does not exceed the second threshold th2 continues for the certain time (such as five seconds) or longer by using the counter 53a (YES in step SP127), the stay determining unit 53 determines that the user UA is continuously staying in the area 4c for the certain time or longer, and it is determined whether the area 4c is a fixed position (home position) for the user UA (step SP128).

When the home position determining unit 58 in the user area identifying apparatus 50 determines on the basis of the user ID that the area 4c with the area number AR4c is not registered in advance as a fixed position (home position) for the user UA (NO in step SP128), the home position determining unit 58 returns to step SP121 again without transmitting the determination result and information of the area number AR4c to the lighting controller 6.

When the home position determining unit 58 in the user area identifying apparatus 50 determines on the basis of the user ID that the area 4c with the area number AR4c is registered in advance as a fixed position (home position) for the user UA (YES in step SP128), the home position determining unit 58 transmits the determination result and information of the area number AR4c to the lighting controller 6.

On receipt of the determination result and the information of the area number AR4c from the user area identifying apparatus 50, the lighting controller 6 in the lighting control system 100 outputs a control signal for turning on the lighting equipment LT4c with an equipment ID (LTD4c) associated with the area number 4c on the basis of the table T1, and switches the lighting equipment LT4c from off to on (step SP129).

In contrast, when the user area identifying apparatus 50 determines that the second difference df2 exceeds the second threshold th2 (YES in step SP126), the user area identifying apparatus 50 determines whether the second difference df2 exceeds the third threshold th3 (step SP130).

When the stay determining unit 53 in the user area identifying apparatus 50 determines that the second difference df2 in the area 4c does not exceed the third threshold th3 (NO in step SP130), this means that a third person different from the user UA has not been detected in the area 4c, and only the user UA has already moved out of the area 4c. At this time, the stay determining unit 53 returns to step SP121 again.

In contrast, when the stay determining unit 53 in the user area identifying apparatus 50 determines that the second difference df2 in the area 4c exceeds the third threshold th3 (YES in step SP130), this means that a third person different from the user UA has been detected in the area 4c.

The stay determining unit 53 in the user area identifying apparatus 50 determines whether the state in which the second difference df2 in the area 4c exceeds the third threshold th3 continues for a certain time (such as five seconds) or longer (step SP131).

When the stay determining unit 53 in the user area identifying apparatus 50 determines that the state in which the second difference df2 exceeds the third threshold th3 continues for the certain time (such as five seconds) or longer by using the counter 53a (YES in step SP131), the stay determining unit 53 determines that a third person together with the user UA is continuously staying in the area 4c for the certain time or longer.

In contrast, when the stay determining unit 53 in the user area identifying apparatus 50 determines that the state in which the second difference df2 in the area 4c exceeds the third threshold th3 does not continue for the certain time (such as five seconds) or longer by using the counter 53a (NO in step SP131), the stay determining unit 53 determines that a third person different from the user UA in the area 4c has passed the area 4c, or a third person together with the user UA has moved out of the area 4c. The stay determining unit 53 returns to step SP130 again without transmitting the determination result and information of the area number AR4c to the lighting controller 6.

The home position determining unit 58 in the user area identifying apparatus 50 determines whether the area 4c is a fixed position (home position) for the user UA (step SP132).

When the home position determining unit 58 in the user area identifying apparatus 50 determines on the basis of the user ID that the area 4c with the area number AR4c is registered in advance as a fixed position (home position) for the user UA (YES in step SP132), the home position determining unit 58 transmits the determination result and information of the area number AR4c to the lighting controller 6.

In contrast, when the home position determining unit 58 in the user area identifying apparatus 50 determines on the basis of the user ID that the area 4c with the area number AR4c is not registered in advance as a fixed position (home position) for the user UA (NO in step SP132), the home position determining unit 58 returns to step SP121 again without transmitting the determination result and information of the area number AR4c to the lighting controller 6.

On receipt of the determination result and the information of the area number AR4c from the user area identifying apparatus 50, the lighting controller 6 in the lighting control system 100 outputs a control signal for turning on the lighting equipment LT4c with an equipment ID (LTD4c) associated with the area number 4c on the basis of the table T1, switches the lighting equipment LT4c from off to on (step SP133), thereby illuminating the surroundings of the user UA and the third person who are staying in the area 4c, and returns to step SP121 again.

### Advantageous Effects

As described above, only when the user UA is continuously staying in, for example, the area 4c of a room of the section S for a certain tine or longer and when it is determined that the area 4c is a home position for the user UA, the lighting control system 100 is able to switch the lighting equipment LT4c in the area 4c from off to on.

That is, even when the user UA is continuously staying in one of the areas 1a to 10e of the section S, if that area is not a home position for the user UA, it is unlikely that the user UA stays in that area for a long time, and accordingly the lighting control system 100 does not turn on the lighting equipment LT in that area.

Therefore, in the lighting control system 100, when a janitor enters a room, which is an internal space, of the section S, and moves around and cleans the areas 1a to 10e, for example, even if the janitor is continuously staying in the area 4c for a certain time or longer, unlike the user UA, no home position is registered for the janitor, and the lighting equipment LT4c in the area 4c is not turned on.

As has been described above, only when the user UA is identified and when the user UA is continuously staying in an area registered in advance as a home position for the user UA for a certain tine or longer, the lighting control system 100 is able to turn on the lighting equipment in that area. Accordingly, a lighting space that is comfortable for the user UA can be provided while reducing the useless power consumption.

### Other Embodiments

The above-described first embodiment has discussed the case where the lighting equipment LT4c is turned on when the user UA is continuously staying in the area 4c for a certain time or longer. The above-described second embodiment has discussed the case where the lighting equipment LT4c is turned on when the user UA is continuously staying in the area 4c for a certain time or longer and when the area 4c is a home position for the user UA. However, the present invention is not limited to these cases, and control may be applied to turn off the lighting equipment LT4c which is in an on state or to modulate the brightness of the lighting equipment LT4c.

The above-described first and second embodiments have discussed the cases where the thermopile SP4c and the indoor thermopiles SPR1a to SPR10e, which are infrared detection sensor arrays, are used as obtaining units. However, the present invention is not limited to these cases, and infrared cameras or thermal image cameras may be used as obtaining units.

Furthermore, the above-described first embodiment has discussed the case where the thermopile SP4c and the lighting equipment LT4c are provided only in the area 4c. However, the present invention is not limited to this case, and thermopiles SP1a to SP10e may be provided in all the areas 1a to 10e, respectively, and the pieces of lighting equipment LT1a to LT10e may be provided in all the areas 1a to 10e, respectively.

In this case, the stay determining unit 53 in the user area identifying apparatus 5 determines that the user UA is continuously staying in each of the areas 1a to 10e when a state where the second difference df2 in each of the areas 1a to 10e does not exceed the second threshold th2 continues for a certain time (such as one second) or longer. In doing so, if the user UA is slowly moving through the areas 1a to 10e, the pieces of lighting equipment LT1a to LT10e in the areas 1a to 10e where the user UA is briefly staying can be turned on and then turned off as the user UA moves. Such control may be applied also to the second embodiment.

Furthermore, the above-described second embodiment has discussed the case where the matching processor 56b in the user area identifying apparatus 50 performs matching using the pixel values of the external thermal image S1 and the pixel values of the internal thermal image H1a to H10e. However, the present disclosure is not limited to this case, and the matching processor 56b may perform matching using various other methods, such as template matching using the feature points of images.

What is claimed is:

1. A lighting control system, comprising:
lighting equipment that illuminates an area;
processing circuitry configured to
sequentially obtain thermal images, each representing a spatial temperature distribution in the area at a corresponding time,
determine whether a user is present in the area, based on one of the obtained thermal images, and
determine whether the user is staying in the area, when it is determined that the user is present in the area, based on a change between the thermal images of the area sequentially obtained by the processing circuitry; and
a control circuit configured to control the lighting equipment in accordance with whether the processing circuitry determines that the user is staying in the area.

2. The lighting control system according to claim 1, wherein the control circuit is further configured to switch the lighting equipment from off to on when the processing circuitry determines that the user is staying in the area.

3. The lighting control system according to claim 1, further comprising:
second processing circuitry configured to
obtain an external thermal image including the user when the user is outside the area;
identify the user based on the external thermal image, when the processing circuitry determines the presence of the user in the area; and
determine whether the area determined by the processing circuitry to be an area where the user is staying is a predetermined home position of the user,
wherein the control circuit is further configured to control the lighting equipment in accordance with whether the area is determined to be the predetermined home position of the user.

4. The lighting control system according to claim 3, wherein the control circuit is further configured to switch the lighting equipment from on to off when the processing circuitry determines that the user is no longer present in the area determined to be the predetermined home position of the user.

5. A lighting control method, comprising:
sequentially obtaining thermal images, each representing a spatial temperature distribution in an area at a corresponding time, the area being illuminated by lighting equipment;
determining, by processing circuitry, whether a user is present in the area, based on one of the obtained thermal images;
determining, by the processing circuitry, whether the user is staying in the area, when it is determined that the user is present in the area, based on a change between the thermal images of the area sequentially obtained; and
controlling, by a control circuit, the lighting equipment in the area when it is determined that the user is staying in the area.

6. The lighting control method of claim 5, wherein the controlling step comprises switching the lighting equipment from off to on when it is determined that the user is staying in the area.

7. The lighting control method of claim 5, further comprising:
obtaining an external thermal image including the user when the user is outside the area;
identifying the user based on the external thermal image, when it is determined that the user is present in the area;
determining whether the area determined to be an area where the user is staying is a predetermined home position of the user; and
controlling the lighting equipment in accordance with whether the area is determined to be the predetermined home position of the user.

8. The lighting control method of claim 7, wherein the controlling step further comprises switching the lighting equipment from on to off when it is determined that the user is no longer present in the area determined to be the predetermined home position of the user.
